(19) United States
(12) Patent Application Publication
(10) Pub. No.: US 2013/0299131 A1
(43) Pub. Date: Nov. 14, 2013

(54) ADJUSTABLE HEAT DISSIPATION ASSEMBLY FOR MAGNETIC DEVICES

(71) Applicants: Alexander TIMASHOV, Rehovot (IL); Oxana SAVVATYEYEV, Holon (IL); Evgenia GIDVARG, Rishon Lezion (IL)

(72) Inventors: Alexander TIMASHOV, Rehovot (IL); Oxana SAVVATYEYEV, Holon (IL); Evgenia GIDVARG, Rishon Lezion (IL)

(21) Appl. No.: 13/470,624

(22) Filed: May 14, 2012

(51) Int. Cl. F28F 9/007; B23P 15/26

(52) U.S. Cl. 165/67; 29/890.03

(57) ABSTRACT

According to embodiments of the present invention, there is provided an adjustable heat dissipation assembly and a method for manufacturing and assembling same. The heat dissipation assembly may include: a heat dissipation frame including a base with at least two side walls, the base and the side walls define an internal space suitable for accommodating a device that requires cooling; and an adjustable plate, configured to be placed over the device in between the side walls, and secured to the side walls, the distance of the adjustable plate from the base of the heat dissipation frame when it is not secured to the side walls being adjustable.

### BACKGROUND OF THE INVENTION

Devices such as inductors, transformers, solenoids, integrated magnetic devices etc., may generate large amounts of heat that may severely damage its components. Therefore, magnetic devices may require the capability to dissipate large amounts of heat energy to the surrounding ambient. Cooling of magnetic devices may be enhanced by attaching a heat sink to the device. A heat sink may typically have large surface area, for example, by including a plurality of thermally conductive fins. Furthermore, to increase heat dissipation rate, the heat sink with its magnetic device may be secured to other heat dissipating elements such as the cooling plate of the power supply.

Planar magnetic devices typically have two external surfaces that are relatively large with respect to the other external surfaces. Typically, the heat sink is attached to one of these larger external surfaces, through an elastic thermal interface layer having low thermal resistance such as thermal silicon or thermal rubber pads. However, in some cases improved thermal dissipation is required. This may be achieved by increasing the contact area between the device and the heat sink. The contact area may be increased by enclosing the device in a heat conducting frame and attaching the heat sink to the frame. Using a heat conducting frame may increase heat dissipation rate by providing additional heat conveying routes from the device's circumference to the heat sink. The frame may be generally U-shaped and may be attached to the side of the device opposite to the side of the heat sink. When assembled, the side walls of the U-shaped frame may face the heat sink. For ease of manufacture, a base plate may be added between the device and the heat sink so that the side walls of the frame may be secured to the base plate using fastening means such as screws. The magnetic device is typically situated at a substantially cubic space defined by the base plate and the U shaped frame. Optionally, elastic and compressible thermal interface layers may be placed, one between the device and the base plate and the other between the device and the frame.

The pressure between the heat dissipation assembly including the frame and base plate and the magnetic device should be controlled to maintain a requisite thermal coupling and facilitate sufficient thermal flow rate, while avoiding too high pressure applied on the magnetic device to prevent undesired mechanical stresses and strains that may damage or even break the device. Especially, too high pressure may break ferrite elements typically being the device's magnetic core.

Assembling the heat dissipation assembly is typically performed by placing a first thermal interface layer adjacent to the base plate, placing the cooled device adjacent to the thermal interface layer, placing a second thermal interface layer adjacent to the cooled device and enclosing the assembly with the U-shaped part. When designing such an assembly, care should be taken for selecting proper sizes of the U-shaped frame and thermal interface layers, such that when assembled, the heat dissipation assembly will press against the cooled device at the desired pressure level.

Reference is made to FIG. 1 which depicts a schematic high-level front view illustration of an exemplary prior art heat dissipation assembly 100. Heat dissipation assembly 100 may include heat dissipation frame 122 and base plate 124. Heat dissipation frame 122 may be generally U-shaped, with the side walls 128 of the heat dissipation frame 122 securable to the base plate at, for example, stubs 126 by any suitable fastening means such as screws (not shown) welding, soldering etc. Cooled device 110 may be placed at a substantially cubic space defined by base plate 124 and heat dissipation frame 122. A first thermal interface layer 132 may be placed between cooled device 110 and base plate 124, and a second thermal interface layer 130 may be placed between cooled device 110 and heat dissipation frame 122. Heat dissipation assembly 100 may be secured to an additional heat sink (not shown) or to a printed circuit board (PCB, not shown).

When designing heat dissipation assembly 100, the internal height of side walls 128 of heat dissipation frame 122, marked on FIG. 1 as L1, should substantially equal the sum of heights of thermal interface layers 130 and 132 and of cooled device 110, marked on FIG. 1 as L2, L3 and L4, respectively, allowing 10-20% deformation to thermal interface layers 130 and 132 due to pressure exerted on them.

However, manufacturing tolerances may cause the dimensions of cooled device 110 and heat dissipation frame 122 to vary. Hence, even if the heights of heat dissipation frame 122 and thermal interface layers 130 and 132 were properly selected, the applied pressure on cooled device 110 may be too high or too low with respect to the desirable pressure. The thermal interface layers are typically thick and compressible, and therefore, may compensate for these manufacturing tolerances, but only to some extent. For example, if side walls 128 of heat dissipation frame 122 are longer than expected, for example, due to manufacturing tolerances, a gap may be formed, for example, between thermal interface layer 130 and heat dissipation frame 122. The gap may cause insufficient thermal coupling and insufficient heat flow between cooled device 110 and heat dissipation frame 122, which may result in poor cooling and overheating of cooled device 110. On the contrary, if side walls 128 of heat dissipation frame 122 are shorter than expected, the pressure applied on cooled device 110 by heat dissipation assembly 100 may be too high, and may lead to deformation or cracks at cooled device 110. For example, if cooled device 110 is a magnetic device including a ferrite core, the ferrite core may break.

### SUMMARY OF THE INVENTION

According to embodiments of the present invention, there is provided an adjustable heat dissipation assembly, the heat dissipation assembly may include: a heat dissipation frame including a base with at least two side walls, wherein the base and the side walls define an internal space suitable for accommodating a device that requires cooling; and an adjustable plate, configured to be placed over the device in between the side walls, and secured to the side walls, wherein distance of the adjustable plate from the base of the heat dissipation frame when it is not secured to the side walls being adjustable.

Furthermore, according to embodiments of the present invention, the adjustable plate may be secured to the side walls by screws, welding or soldering.

Furthermore, according to embodiments of the present invention, a thermal interface layer may be placed between the device and the adjustable plate.

Furthermore, according to embodiments of the present invention, a thermal interface layer may be placed between the device and the base of the heat dissipation frame.

Furthermore, according to embodiments of the present invention, each of the heat dissipation frame and the base may be made of a material which is selected from steel, aluminum, copper, brass and impregnated polymer.

Furthermore, according to embodiments of the present invention, the adjustable plate may be secured to the side walls at a distance from the base of the heat dissipation frame so as to provide a predetermined pressure against the base.

Furthermore, according to embodiments of the present invention, distance between the side walls may be adjustable.

Furthermore, according to embodiments of the present invention, the heat dissipation assembly may include at least one filler placed in at least one gap formed between the adjustable heat dissipation assembly and the sections of coils of the device protruding from a ferrite core of the device to provide low-resistance heat dissipation path from those sections to the heat dissipation assembly.

According to embodiments of the present invention, there is provided a method for assembling an adjustable heat dissipation assembly, the method may include: providing a heat dissipation frame including a base and at least two side walls facing each-other, the base and the side walls may define an internal space suitable for accommodating a device that requires cooling; placing the device within the internal space; placing an adjustable plate adjacent to the device; adjusting the distance of the adjustable plate from the base of the heat dissipation frame; and securing the adjustable plate to the side walls of the heat dissipation frame.

Furthermore, according to embodiments of the present invention, the method may include securing the adjustable plate to the side walls by screws, soldering or welding.

Furthermore, according to embodiments of the present invention, the method may include placing a thermal interface layer between the device and the adjustable plate prior to the placing of the adjustable plate next to the device.

Furthermore, according to embodiments of the present invention, the method may include placing a thermal interface layer between the device and the base of the heat dissipation frame prior to the placing of the device within the internal space.

Furthermore, according to embodiments of the present invention, each of the heat dissipation frame and the base may be made of a material which is selected from: steel, aluminum, copper and impregnated polymer.

Furthermore, according to embodiments of the present invention, securing the adjustable plate to the side walls may be performed at a distance from the base of the heat dissipation frame so as to provide a predetermined pressure against the base.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic high-level front view illustration of an exemplary prior art heat dissipation assembly;

FIG. 2 is a schematic high-level front view illustration of an exemplary adjustable heat dissipation assembly according to embodiments of the present invention;

FIG. 3 is a schematic high-level side view illustration of the exemplary adjustable heat dissipation assembly according to embodiments of the present invention;

FIG. 4 is a schematic high-level isometric illustration of an exemplary adjustable plate according to embodiments of the present invention;

FIG. 5 is a schematic high-level front view illustration of an exemplary extended adjustable heat dissipation assembly according to embodiments of the present invention;

FIG. 6 is a schematic high-level cross sectional view illustration of the exemplary extended adjustable heat dissipation assembly presented in FIG. 5, according to embodiments of the present invention; and

FIG. 7 is a flowchart illustration of a method for assembling the adjustable heat dissipation assembly according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Although embodiments of the present invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed at the same point in time.

As used herein, a cooled device, such as cooled device 110 may refer to any magnetic device which requires cooling. The device may be, for example, any magnetic device such as a coil, an inductor, a transformer, a solenoid, an integrated magnetic device, etc. Typically, the cooled device includes at least one electrically conductive coil disposed in a ferrite core, such that the ferrite core surrounds the at least one coil at least along part of its longitudinal axis.

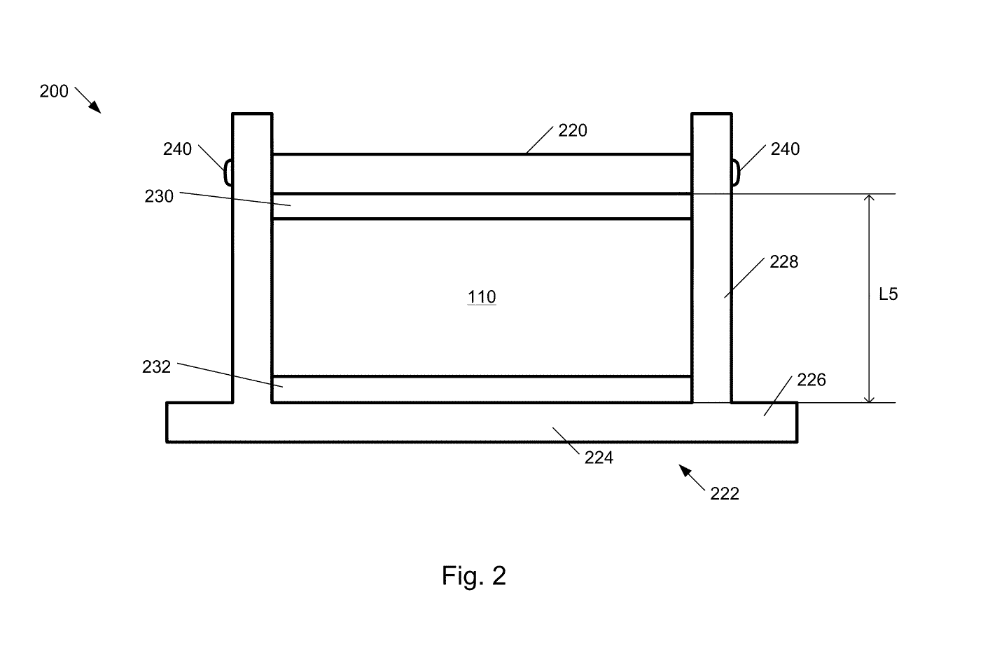

Reference is made to FIG. 2 which depicts a schematic high-level front view illustration of an exemplary adjustable heat dissipation assembly 200 according to embodiments of the present invention. According to embodiments of the present invention adjustable heat dissipation assembly 200 may include heat dissipation frame 222 and an adjustable plate 220. When assembled, heat dissipation frame 222 and adjustable plate 220 are thermally connected to provide low thermal resistance. Heat dissipation frame 222 may be generally U-shaped, and may include a substantially flat base 224 and two perpendicular side walls 228 facing each-other. Base 224 and side walls 228 may be thermally connected to provide low thermal resistance. Base 224 and side walls 228 may define an internal space suitable for accommodating cooled device 110 with good suitability. For example, side walls 228 may be substantially rectangular and parallel to each other, such that the internal space defined by base 224 and side walls 228 may be substantially cubic. Heat dissipation frame 222 may include stubs 226 for further securing adjustable heat dissipation assembly 200 to a heat sink or to a PCB.

It should be noted that embodiments of the present invention ate not limited to the specific design described hereinabove. For example, side walls 228 may not be rectangular or parallel to each other, and may be designed to fit the specific shape of cooled device 110. Additionally, heat dissipation frame 222 may include more than two side walls to define the internal space for the cooled device. Thus, other shapes of heat dissipation frame 222 may be utilized, all of them providing good thermal engagement to cooled device 110 and allowing connection of adjustable plate 220 with adjustable pressure.

Cooled device 110 may be placed at the space defined by heat dissipation frame 122. A first thermal interface layer 232 may be placed between cooled device 110 and heat dissipation frame 222, and a second thermal interface layer 230 may be placed between cooled device 110 and adjustable plate 220.

Adjustable plate 220 may be placed over cooled device 110, adjacent to thermal interface layer 232 in between the side walls, and be secured to side walls 228 of heat dissipation frame 222, for example, by screws 240. Alternatively or additionally, any suitable fastening means may be used, such as soldering or welding, to secure adjustable plate 220 to its place, where a desired pressure is applied to cooled device 110 and thermal interface layers 232. The distance of adjustable plate 220, from base 224 of heat dissipation frame 222, marked as L5 on FIG. 2, may be adjusted before securing adjustable plate 220 to side walls 228 of heat dissipation frame 222. The distance of adjustable plate 220 from base 224 of heat dissipation frame 222 may be adjusted to a distance in which adjustable heat dissipation assembly 200 presses against cooled device 110 at a predetermined pressure. Adjustable plate 220 may be placed substantially parallel to base 224.

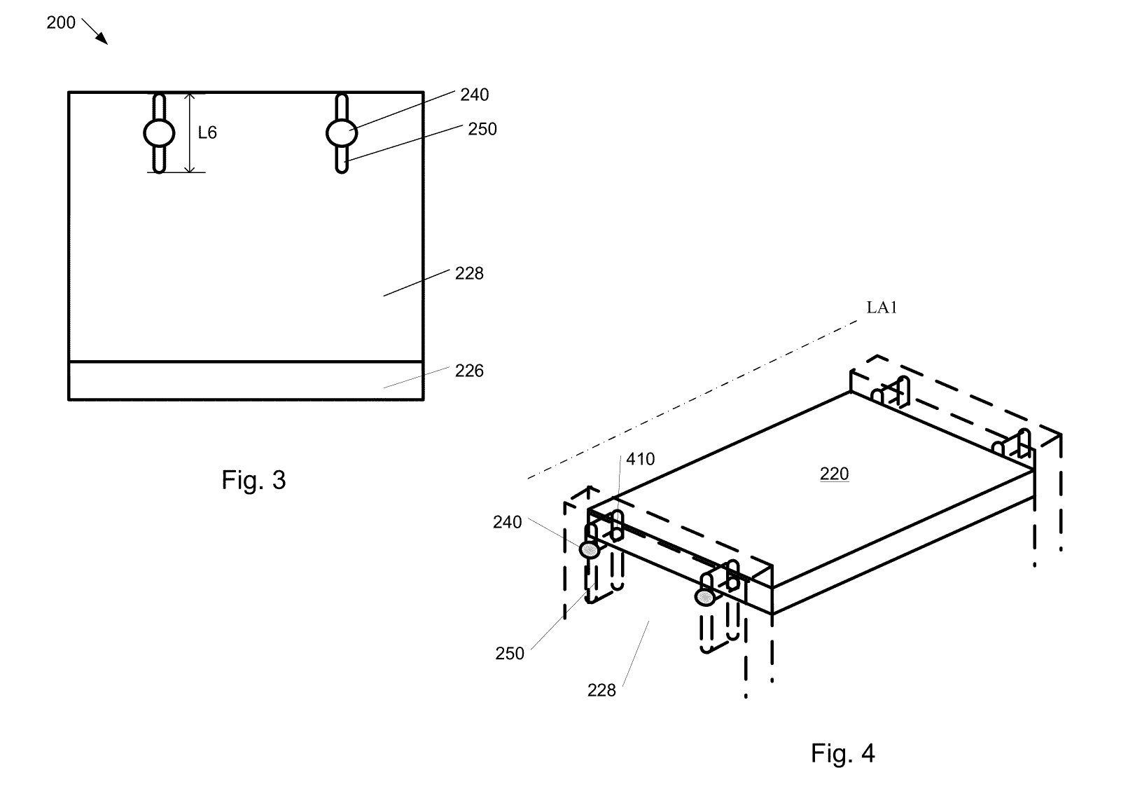

Reference is made to FIG. 3 which depicts a schematic high-level side view illustration of exemplary adjustable heat dissipation assembly 200 according to embodiments of the present invention. According to embodiments of the present invention each side wall 228 of heat dissipation frame 222 may include a plurality of elongated bores 250. Screws 240 may secure adjustable plate 220 to side walls 228 of heat dissipation frame 222, however, the specific distance of screws 240 and adjustable plate 220 from base 224 (seen in FIG. 2) may be adjusted along the longitudinal dimension of elongated bores 250, marked on FIG. 3 as L6. Screws 240 may enhance the thermal coupling between adjustable plate 220 and heat dissipation frame 222, providing heat conveying routs from adjustable plate 220 to dissipation frame 222. In case soldering or welding is used to secure adjustable plate 220 to heat dissipation frame 222, the welding or soldering points may provide heat conveying routs from adjustable plate 220 to dissipation frame 222.

Reference is made to FIG. 4 which depicts a schematic high-level isometric illustration of exemplary adjustable plate 220 according to embodiments of the present invention. According to embodiments of the present invention adjustable plate 220 may include a plurality of bores 410, at locations corresponding to elongated bores 250 of heat dissipation frame 222, so that when assembled as described hereinabove, screws 240 may fit into bores 410.

Heat dissipation frame 222 and adjustable plate 220 may be made from any rigid and highly thermally conductive material such as aluminum, copper, steel, brass or even impregnated polymer material. In some embodiments a combination of materials may be used. For example, heat dissipation frame 222 may be made of steel while adjustable plate 220 may be made of aluminum or even impregnated polymer material. Thermal interface layers 230 and 232 may be made from any compressible and elastic material characterized by being electrically insulating and thermally conductive, such as thermal silicon or thermal rubber.

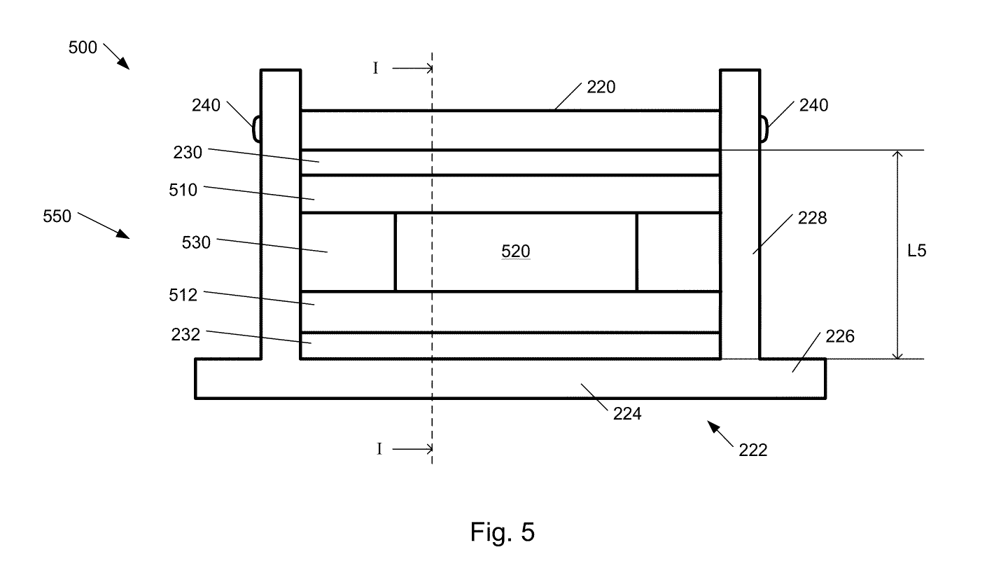

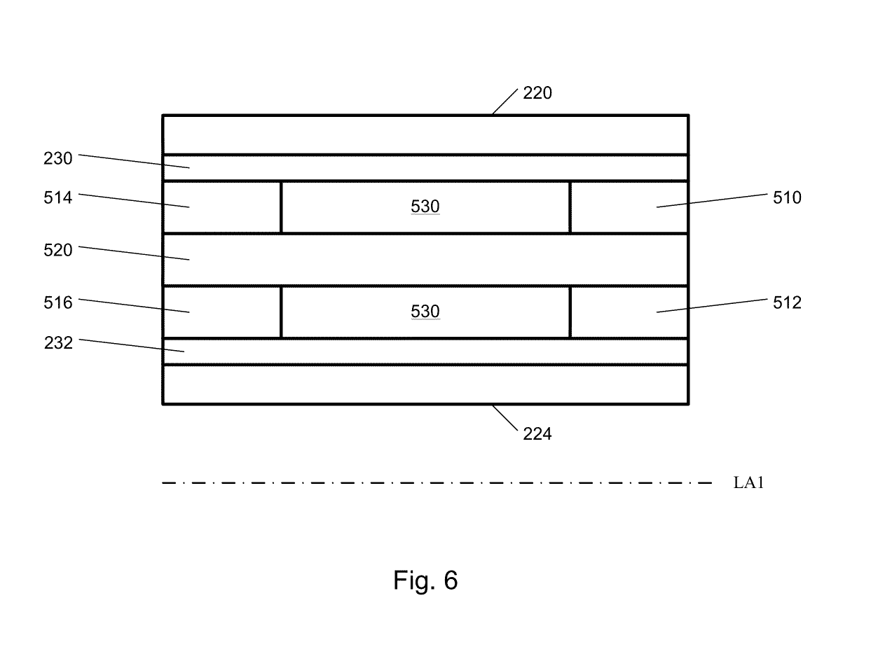

Reference is now made to FIGS. 5 and 6 which depict a schematic high-level front view illustration, and a schematic cross section view along section plane I-I marked on FIG. 5 illustration, respectively, of an exemplary extended adjustable heat dissipation assembly 500 according to embodiments of the present invention.

According to some embodiments of the present invention, the length of heat dissipation assembly 200 along its longitudinal axis LA1 may substantially or approximately equal the length of the ferrite core 530 of cooled device 550. Longitudinal axis LA1 being the axis parallel to base 224 and to side walls 228. In this case, ferrite core 530 is thermally coupled directly to heat dissipation assembly 200, while the coils 520 of cooled device 550 are indirectly coupled to heat dissipation assembly 200 through ferrite core 530. During operation of cooled device 550, both ferrite core 530 and coils 520 may generate heat. Since coils 520 are not directly coupled to heat dissipation assembly 200, cooling of coils 520 may be less effective than cooling of ferrite core 530. In many applications, coils 520 may be longer than ferrite core 530 along longitudinal axis LA1. Thus, coils 520 may extend beyond ferrite core 530 along longitudinal axis LA1. According to embodiments of the present invention, heat dissipation assembly 200 may be extended to be thermally coupled directly also to coils 520.

According to some embodiments of the present invention, heat dissipation assembly 500 may be longer than ferrite core 530 along longitudinal axis LA1. Extended heat dissipation assembly 500 may include, in addition to the components of heat dissipation assembly 200, at least one filler selected from fillers 510, 512, 514 and 516. Fillers 510, 512, 514 and 516 may be placed in gaps formed between adjustable plate 220 and the sections of coils 520 protruding from ferrite core 520, and in gaps formed between base 224 the sections of coils 520 protruding from ferrite core 520, to provide low-resistance heat dissipation path from those sections to the heat dissipation assembly. For example, fillers 510, 512, 514 and 516 may be placed in the gaps formed between thermal interface layers 230 and 232 and the sections of coils 520 protruding from ferrite core 520. Fillers 510, 512, 514 and 516 may be made of thermally conductive material or combination of materials, and should provide electrical insulation between coils 520 and heat dissipation assembly 500. For example, fillers 510, 512, 514 and 516 may be made of Aluminum, Copper, Ceramics, compressible thermal interface, etc. For example, fillers 510, 512, 514 and 516 may be made of Aluminum, and may be electrically insulated from coils 520 by a thin layer of electrically insulating and thermally conducting material. Alternatively, different segments of adjustable plate 220 may have different heights with respect to base 224, designed to fit the different heights of ferrite core 530 and the sections of coils 520 protruding from ferrite core 520.

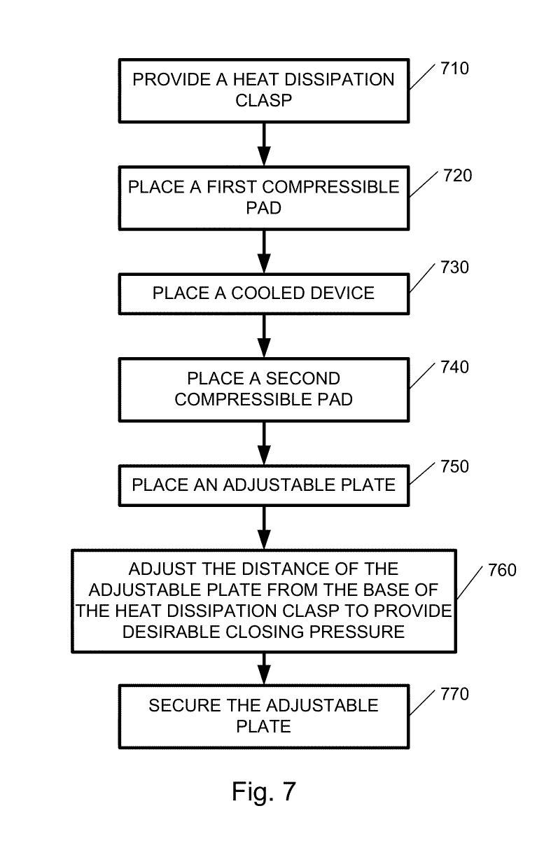

Reference is now made to FIG. 7 which is a flowchart illustration of a method for assembling adjustable heat dissipation assembly 200 according to embodiments of the present invention. According to embodiments of the present invention, heat dissipation frame 220 may be provided (block 710). Optionally, a first thermal interface layer 232 may be placed (block 720) inside the internal space defined by heat dissipation frame 122. Such that first thermal interface layer 232 may be placed next to the internal part of base 224. Cooled device 110 may be placed (block 730) adjacent to first thermal interface layer 232 within the space defined by heat dissipation frame 122. If first thermal interface layer 232 is not used, cooled device 110 may be placed next to the internal part of base 224. Optionally, a second thermal interface layer 230 may be placed (block 740) adjacent to cooled device 110 within the space defined by heat dissipation frame 122. Adjustable plate 220 may be placed adjacent to second thermal interface layer 230, within the space defined by heat dissipation frame 122. Adjustable plate 220 may be placed (block 750) next to second thermal interface layer 230. If second thermal interface layer 230, is not used, adjustable plate 220 may be placed (block 750) next to cooled device 110. The distance of adjustable plate 220 from base 224 may be adjusted (block 760) to apply a predetermined pressure on cooled device 110 by adjustable heat dissipation assembly 200. For example, the distance of adjustable plate 220 from base 224 may be adjusted manually by trained personnel, or automatically by an assembling machine. For example, the distance of adjustable plate 220 from of second base 224 may be adjusted passively by placing adjustable plate 220 on top thermal interface layer 230, when base 224 is facing down towards earth, and letting gravity pull adjustable plate 220 to the right place. Alternatively, the pressure applied by heat dissipation assembly 200 on cooled device 110 may be controlled. For example, the assembling machine may press adjustable plate 220 against base 224 at a predetermined pressure. The pressing pressure or force may be verified, at a single location or at a plurality of locations, using, for example, a sensor or a plurality of sensors, such as a force sensor, load cells etc. For example, the pressing pressure or force may be verified at four corners of adjustable plate 220 to ensure substantially uniform pressing pressure along adjustable plate 220. Adjustable plate 220 may be placed substantially parallel to base 224. After the distance of adjustable plate 220 from base 224 is adjusted, adjustable plate 220 may be secured (block 770) to side walls 228 of heat dissipation frame 222. Adjustable plate 220 may be secured to side walls 228 of heat dissipation frame 222 using any suitable method such as by screwing, welding, soldering etc. Optionally, heat dissipation frame 220, thermal interface layers 230 and 232, cooled device 110 and adjustable plate 220 may be glued by an appropriate resin, or otherwise separated by a suitable thermally conductive interposer.

It should be noted that while embodiments of the present invention are presented having a single adjustable plate 220, embodiments of the present invention may be augmented to include more than one adjustable plate. For example, one of side walls 228 may be adjustable as well, such that the distance between the side walls 228 is adjustable. For example, the adjustable side wall may be placed and fixed to base 224 in a controlled manner, after placing cooled device 110, and before placing adjustable plate 220. For example, the pressing pressure or force applied by the adjustable side wall on cooled device 110 may be verified using at least one sensor, and the adjustable side wall may be secured to base 224 by welding.

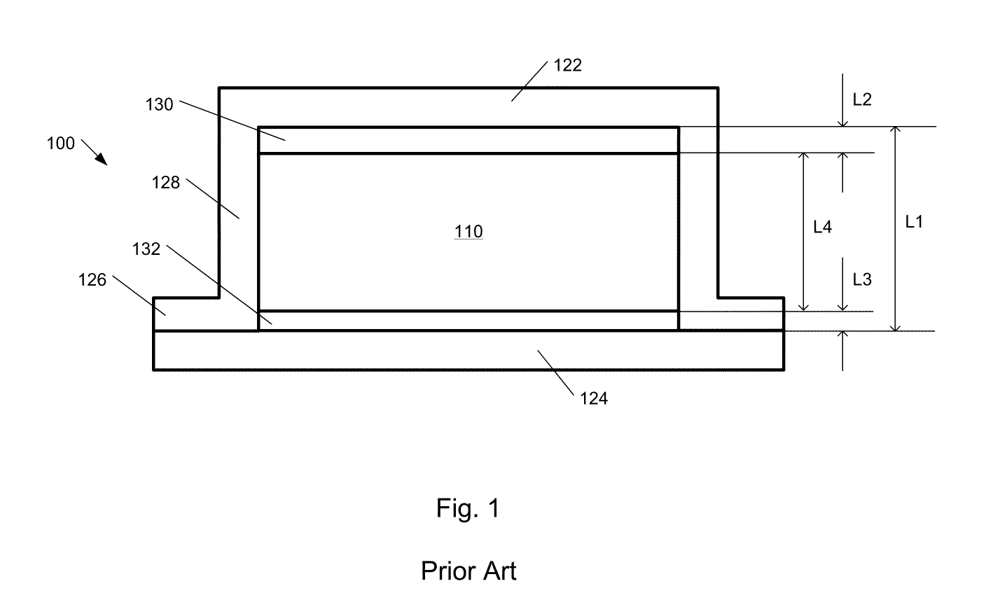

According to embodiments of the present invention, having the height of adjustable plate 220 adjustable, and controlling the closing pressure of the heat dissipation assembly may ensure that the pressure applied on cooled device 110 is within the desired pressure range. i.e. the closing pressure may be high enough to provide sufficient thermal coupling to facilitate proper thermal flow and cooling of cooled device 110, but not too high, to prevent undesired mechanical stresses and strains that may damage or even break cooled device 110. Additionally, thermal interface layers 230 and 232 no longer have to compensate for variations of dimensions of cooled device 110 and heat dissipation assembly 200, caused for example, due to production tolerances. Therefore, thermal interface layers 230 and 232 used in heat dissipation assemblies, made according to embodiments of the present invention, may be thinner with respect to thermal interface layers 130 and 132 used in prior art heat dissipation assemblies, such as heat dissipation assembly 100 presented in FIG. 1. This may reduce the total cost of the heat dissipation assembly and improve the thermal coupling between cooled device 110 and the heat dissipation assembly.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An adjustable heat dissipation assembly comprising:
a heat dissipation frame comprising a base with at least two side walls, wherein the base and the side walls define an internal space suitable for accommodating a device that requires cooling; and
an adjustable plate, configured to be placed over the device in between the side walls, and secured to the side walls, wherein distance of the adjustable plate from the base of the heat dissipation frame when it is not secured to the side walls being adjustable.

2. The adjustable heat dissipation assembly of claim 1, wherein the adjustable plate is secured to the side walls by screws.

3. The adjustable heat dissipation assembly of claim 1, wherein the adjustable plate is secured to the side walls by welding.

4. The adjustable heat dissipation assembly of claim 1, wherein a thermal interface layer is placed between the device and the adjustable plate.

5. The adjustable heat dissipation assembly of claim 1, wherein a thermal interface layer is placed between the device and the base of the heat dissipation frame.

6. The adjustable heat dissipation assembly of claim 1, wherein each of the heat dissipation frame and the base are made of a material which is selected from the list consisting of: steel, aluminum, copper, brass and impregnated polymer.

7. The adjustable heat dissipation assembly of claim 1, wherein the adjustable plate is secured to the side walls at a distance from the base of the heat dissipation frame so as to provide a predetermined pressure against the base.

8. The adjustable heat dissipation assembly of claim 1, wherein distance between the side walls is adjustable.

9. The adjustable heat dissipation assembly of claim 1, comprising at least one filler placed in at least one gap formed between the adjustable heat dissipation assembly and the sections of coils of the device protruding from a ferrite core of the device.

10. A method for assembling an adjustable heat dissipation assembly, the method comprising:
providing a heat dissipation frame comprising a base and at least two side walls, wherein the base and the side walls define an internal space suitable for accommodating a device that requires cooling;
placing the device within the internal space;
placing an adjustable plate adjacent to the device;
adjusting the distance of the adjustable plate from the base of the heat dissipation frame; and
securing the adjustable plate to the side walls of the heat dissipation frame.

11. The method of claim 8, comprising securing the adjustable plate to the side walls by screws.

12. The method of claim 8, comprising securing the adjustable plate to the side walls by welding.

13. The method of claim 8, comprising placing a thermal interface layer between the device and the adjustable plate prior to the placing of the adjustable plate next to the device.

14. The method of claim 8, comprising placing a thermal interface layer between the device and the base of the heat dissipation frame prior to the placing of the device within the internal space.

15. The method of claim 8, wherein each of the heat dissipation frame and the base are made of a material which is selected from the list consisting of: steel, aluminum, copper and impregnated polymer.

16. The method of claim 8, wherein the securing the adjustable plate to the side walls is performed at a distance from the base of the heat dissipation frame so as to provide a predetermined pressure against the base.
